(19) United States
(12) Patent Application Publication
(10) Pub. No.: US 2015/0222882 A1
(43) Pub. Date: Aug. 6, 2015

(54) DETACHABLE, ADJUSTABLE SCREEN MODIFIER FOR FULL-DEPTH VIEWING

(71) Applicant: EOS Vision, Inc., Scottsdale, AZ (US)

(72) Inventors: Fori Owurowa, Scottsdale, AZ (US); John H. Prince, Los Altos, CA (US)

(73) Assignee: EOS Vision, Inc., Scottsdale, AZ (US)

(21) Appl. No.: 14/173,756

(22) Filed: Feb. 5, 2014

(51) Int. Cl. H04N 13/04

(52) U.S. Cl. CPC H04N 13/0402

(57) ABSTRACT

A screen modifier which is light-weight and low cost can be made with a system of apertures and Fresnel lenses to create full depth viewing in almost any existing TV or viewing device. It can be made detachable and adjustable. The effect is wholly natural with no glasses needed. Especially with the newer 4K screens the resulting images are in high definition, or HD. The orderly setup of the screen modifier allows a TV screen to be written to from a remote capture device with data streaming across the Internet in real time. The technology can be applied to TVs, tablets, monitors and cell-phones. It may be useful for remote surgery.

### BACKGROUND OF THE INVENTION

1. Field of the Invention

The capture of images for full depth viewing can be done with multiple coordinated imaging devices, and most frequently with just two. Presently, and for the most part, these images are stored, manipulated and then re-created as multiple images for viewing on flat screens. To see the images in full-depth observers are obliged to wear switching, polarized or anaglyph glasses. With varying degrees of success this has been done for many years. What has been done with much more difficulty is to re-create the images without the use of glasses, and more difficult still to do this without converting from capture to display format in milliseconds, that is, in real time.

Within the field of seeing without glasses (auto-stereoscopy) a number of techniques have been used to re-create full-depth images from flat screens. The most successful of these has been lenticular arrays, in which each cylindrical lens creates multiple points of view by bending the light from several LEDs, giving in aggregate an observer a vivid sense of depth. This is especially true at “sweet spots”, where a confluence of beams arrive in close coincidence.

A different technique physically divides the light from the emitting elements into left and right with small strips, so that each eye sees just one half of the full perspective. These are called “parallax barriers”. They have long been used, but are generally limited to just two points of view. Efforts to make them work well include liquid crystals, active barriers, reversed barriers and multiple barriers.

Another promising approach is a rear projection system with multiple points of view, possibly hundreds. This replicates the way we see scenes with our eyes, taking in innumerable snapshots from different perspectives to create full depth panoramas in our visual cortex. This approach requires as many cameras and as many projectors as there are points of view to recreate. These cameras and projectors must all be carefully coordinated both in capture and display. Even small failures, such as those of intensity or color balance, in any camera or projector will leave streaks in the display. For so many imaging devices storage requires considerable memory and streaming substantial bandwidth. Nonetheless multiple projectors can produce full-depth and full-parallax images of great quality.

A further technique, still under development, uses tiny flipping solid-state mirrors to guide light through narrow-angle screens to create images of differing viewpoints. This technique, totally coordinated through software, may be very successful one day.

2. Description of the Related Art

Renaissance artists used tricks of light and perspective to create full-depth effects by focusing a viewer's interest on the mains subjects of their compositions. One example are paintings of Mary holding the baby Christ (e.g. Georges de la Tour, 1644). In this and similar pictures the baby Christ is brightly lit, attracting the one's attention to Him, with onlookers receding into a darkening background. Today, with high-speed computers, a viewer's attention can be convincingly redirected to different parts of an action in milliseconds, mimicking the action of our eyes, giving us a full-depth effect. This process is called foveation, since the attention of the eye is drawn to the action by its most sensitive element, the fovea, and all the rest is reduced to peripheral (or less noticed) vision.

For the past century cinematographers have also used the separation of colors, in their simplest division of blue and red, to redirect the different perspectives, for example blue to the left eye and red to the right. The viewer uses glasses typically called anaglyph, since the spectrum is carved away at its blue and red extremes to minimize color (and image) overlap. This inexpensive technique is still used, though most viewers find the color differences to their two eyes somewhat disconcerting.

Almost a century ago another technique was introduced called parallax barrier in which the “blue” and “red” (in this case different perspectives) were separated in viewers' eyes by the parallax (or viewing) angle. In the 1990s Sharp developed an electronic flat-panel application of this technology to commercialization, briefly selling laptops with the world's only 3D LCD screens. Parallax barrier screens are still used but appear dark and generally have a limited viewing angle.

A later technique, born in the 1980s, was to use a system of cylindrical lenslets slanting at an angle close to 33° to the screen vertical, and with a number of separate perspectives (typically from four to nine for each lenslet) to create a full-depth effect. This technology has been very successful in advertising and signage. The screens are very bright, and the images can appear to come straight out at a viewer to give the viewer a brilliant effect of a product. These screens work since viewers are typically at some distance from the screens (optimally at 4 meters) and do not see the low resolution near the screens, where pixels are used up by the multiple perspectives. A viewer also has to be optimally situated in angle (at one “sweet spot” of several) to see a screen in full depth.

Since the cylindrical lenslet approach has been successful, attempts have been made to “convert” (or write to) the screens in real time. This conversion in real-time has had to overcome internal software obstacles, and so far no-one has been very successful. To this day all moving signage images are created by programmers frame by frame on their computers. Consequently computer-generation (or CG) is a very lengthy and expensive process.

A typical glasses-free signage screen is optimally of a size between 24″ and 48″. Because of the particular alignment of the optics the screen cannot be manufactured easily either smaller or larger. The plastic lenslets are fragile and must be carefully wiped, if cleaned at all. To preserve optical alignments the system is massively designed and in consequence heavy. A typical cost is $10,000 each. These are all barriers to universal acceptance by consumers.

What is required for today's glasses-free viewing is a 2D TV or monitor screen which can be modified inexpensively and display full-depth images in real-time using simple, unconverted code. The screen must light in weight. In other words, we require a solution which can be universally accepted by viewing audiences in their own homes.

It is also highly desirable to give the consumer a screen modifier which is easy to attach to a normal TV or monitor so that anyone can enjoy full-depth viewing inexpensively.

Happily, one such solution has been actualized in the following invention.

### SUMMARY OF THE INVENTION

By allowing light to be guided from a TV to an observer through a series of apertures to a condensing lens where it is bent to become parallel or just slightly divergent, a modifier to a flat (and nowadays curved) TV screen can be made to simulate full-depth images to our eyes without our needing glasses. Substantially all the light so flowing is captured. The appearance of a scene is wholly natural. With the arrival of 4K screens the images can also be made in high definition, or HD.

For the natural re-creation of a scene in full-depth, the alignment, spacing, shape of the apertures must be very precise, as must be the separation of the apertures from the emitting elements, and the separation of apertures from a condensing lens. As an added refinement for directing the light there may be a series of lenses. With these lenses the images can also be magnified to enhance the full-depth effect.

The shape of the apertures and their proximity to emitting elements (such as LEDs) is driven by the need to shape light beams and eliminate overlaps. For example, to steer the beams from two adjacent emitting elements the apertures will appear in cross-section as crosses. In fact in our case the light-beams themselves may cross each other. The corresponding walls will appear as diamonds, ovals, rectangles and (in its most simple utilitarian form) circles. In their correct diameters the circles can be cylindrical in the form of threads or wires. Cylinders and other shapes can be drawn, deposited and printed. Precise printing can be done with 3D printers.

For large TV screens a series of lenses for shaping and condensing light will for utility be Fresnel lenses. For compactness the condensing lenses will be of short focal length. For appearance the condensing lenses will have finely divided sub-lenses, or lenslets.

For steering and shaping light beams the Fresnel lenses will be linear. For condensing the Fresnel lenses will be concentric.

Within the present invention we would prefer, for accuracy, that our added elements for creating full-depth viewing be incorporated by a manufacturer. However, the elements we add can also be made attachable and detachable at a reasonable cost (that is, at much less cost than the purchase of a new viewing system). Together these elements form light-weight adjustable screen modifiers.

With foreknowledge of the geometry of any television or lap-top, a screen modifier can be made to retrofit any type of viewing device.

Further, when upgrades to existing technology are created old screen modifiers can be quickly and effectively switched out for new without the expense of buying new TVs.

The means of attachment combined with the ability to convert flat to full depth vision efficiently becomes a part of this invention. This applies particularly to newer 4K TVs or monitors of any size.

Especially with the increasing resolution of TV screens such as UHD, or 4K, the viewing between full-depth and flat can be switched back and forth without any physical alteration to a set-up with a single click of a mouse, yet still remain high-definition (HD).

The utility driving the TV screens, thus modified, will be our own software.

### BRIEF DESCRIPTION OF THE DRAWINGS

This invention, with its many further advantages noted below, may be best understood by referring to the following descriptions together with the accompanying drawings, in which like numbers refer to like elements, and in which:

FIG. 1 shows a section cut horizontally through a screen modifier as it would apply to a display such as a TV screen. The modifier consists of a set of optical elements (prisms or lenses) 2 separated from a series of apertures created (in this case) by a wire mesh 3. FIG. 1 also shows an LED (or pixel) array 4, which is embedded in the imaging device (such as a TV set) with which the apertures 3 must be well aligned. Also in FIG. 1 are shown (in algebraic notation) the dimensions to be defined or calculated.

To give a sense of scale FIG. 2 shows some typical dimensions, deriving from a TV screen with a 55″ diagonal. These would be the period of the LEDs p (0.025″), plus the separation of our eyes e (2.50″). These help determine the other parameters of this invention. (We will refer to LEDs and LCDs collectively as “light emitting elements”, sometimes simply as LEDs, sometimes as pixels).

FIG. 3 shows a configuration of a simple screen modifier such as a Fresnel lens system 2 combined with apertures 3. Here we show the embedded LEDs 4 as point sources and the Fresnel elements 25 as lenses.

FIG. 4 shows several items: the geometry of possible apertures; the paths of light beams at the extreme vertical edge of the screen modifier, with the refraction angles necessary to direct the images towards a central observer; and the separation of the apertures from the Fresnel lens through an intervening substrate 100.

FIG. 5 is a sketch of left and right beams diverging through a system of apertures 3 towards a condensing lens 5, which causes them to run almost parallel towards a pair of eyes 1.

FIG. 6 is an isometric sketch of the apertures in previous figures in the practical form of a mesh 50.

FIG. 7 shows a practical manner in which a screen modifier can be hung on an existing TV set so that a customer can be free to make adjustments. That is, by attaching the modifier to the TV with Velcro or its equivalent. The adjustment screws in subsequent figures can then push or pull the screen modifier to bring it into perfect registration with the TV.

FIG. 8 shows one mechanical arrangement of the screen modifier 100 on a TV set 110. This TV set happens to have a ferrous edge 101 simplifying an attachment using pads or magnets 102.

FIG. 9 shows details of this arrangement for precisely aligning the screen modifier 100 with the TV screen 110 using thumbscrews 105.

FIG. 10 shows an alternative means of mounting the screen modifier 100 onto an existing TV 125 or monitor which has a glass or plastic bezel using the Velcro pads 131 and 132.

FIG. 11 shows how feathering (anti-aliasing) can be applied to an arrangement of flat-strip apertures. The curves 70 shows light as a binary on-off through the apertures. The curves 71, 72 and 73 show light-levels across an aperture with feathering applied.

FIG. 12 shows an alternative arrangement of the apertures, running diagonally across the LEDs. This is useful if we wish to see a TV in both landscape and portrait modes by simply rotating the unit. This is particularly useful for smaller devices such as tablets.

FIG. 13 shows the possibility of using apertures to create three, four or more images, with the light (here from four LEDs) going through an aperture only wide enough for one.

### DETAILED DESCRIPTION OF THE INVENTION

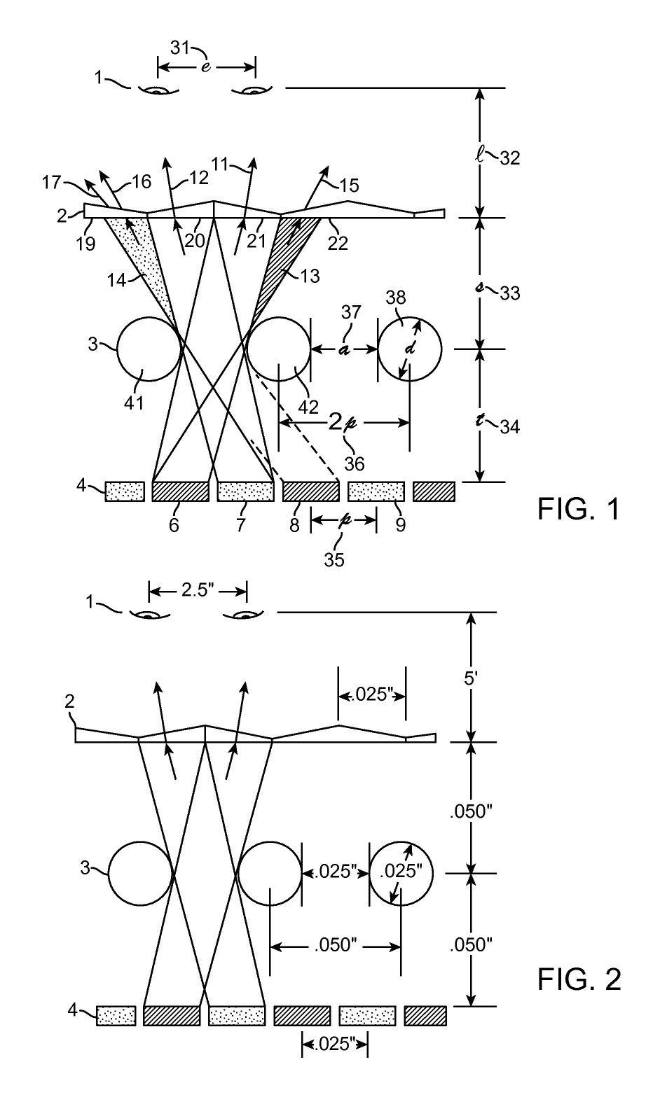

FIG. 1 shows a horizontal cross-section of the present invention, with a pair of eyes 1 looking through a Fresnel lens 2 at an LED array 4 through a series of apertures 3.

In FIG. 1 it is useful, for computational purposes, to describe the geometry in symbols compatible with existing literature: e is the distance between human eyes; p is the period of the LED array; 2p is the period of the apertures, of necessity twice that of the LED array; d is the diameter of some threads or wires, which normally occlude about half of the aperture; a is the width of the aperture, normally about the width of an LED, and such that a+d=2p. In the simplest case a=d.

Also in FIG. 1 we show the distances from the eyes to the Fresnel lens as l; from the Fresnel lens to the apertures as s: and from the apertures to the LEDs as t.

In our example from FIG. 1 we can now illustrate this geometry with some numbers, as in FIG. 2. The distance between human eyes e (31) is normally taken to be about 2½″ (62 mm) so we may take that as datum. The period between LEDs p (35) on a large 1920×1080 screen (with a 55″ diagonal) is 0.025″ so that may also be a reference. The period between apertures 2p (36) is twice that of the LEDs, so that will become 0.050″. If the aperture a (37) at 50% opening is 0.025″ then the diameter d (38) of the wires will also be 0.025″ because a+d=2p. The aperture is a design variable so (to improve performance) if a could be grown by (say) 8% to 0.027″, then the wire diameter d would decrease to 0.023″.

In our example from FIG. 1 we must also include the distance s (33) from the Fresnel lens 2 to the apertures 3. For reasons of symmetry (in this case) from the LEDs 4 this may be the same as the distance t (34) from the LEDs to the apertures, so that would be 0.050″. Once again to improve performance t could be varied, and this adjustment is built into the final design.

In our example from FIG. 1 we will also study the shape of the Fresnel lens 2, which is critical to the implementation of the apertures 3.

Picking the light from LED 7 (which happens to be most usually the “red” LED whose light is destined for the right eye) the main body of light from LED 7 passes unobstructed through the aperture to squarely encounter the element 20 of the Fresnel lens 2. This element 20 is a conventional wedge (or prism) and in this example the light enters an angle of 15° to normal and exits at an angle of less than 1° (the wedge's refractive index of 1.5 giving it a wedge angle of 10°). This “main body of light” 12, as we refer to it, continues on to the right eye at this small angle of 1° to give a comfortable viewing distance of about five feet.

Conversely in FIG. 1 the light from LED 6 (which happens to be most usually the “blue” LED whose light is destined for the left eye) the main body of light 11 passes unobstructed through its aperture to squarely encounter the element 21 of Fresnel lens 2. This light is also refracted to enter the left eye at the same viewing distance.

As may be seen, Fresnel lens 2 is not a normal lens but a series of linear and opposing wedges (prisms) with the function of directing the light from the LEDs to a comfortable viewing distance. The observer can then see the main body of light from two different perspectives as full-depth in a natural manner

The pixel image format for FIG. 1 with its prisms running vertically is normally

LRLR

LRLR

LRLR

with the pixels (LEDs) 6, 8 etc. creating the left-eye images and the pixels (LEDs) 7, 9 etc. creating the right-eye images.

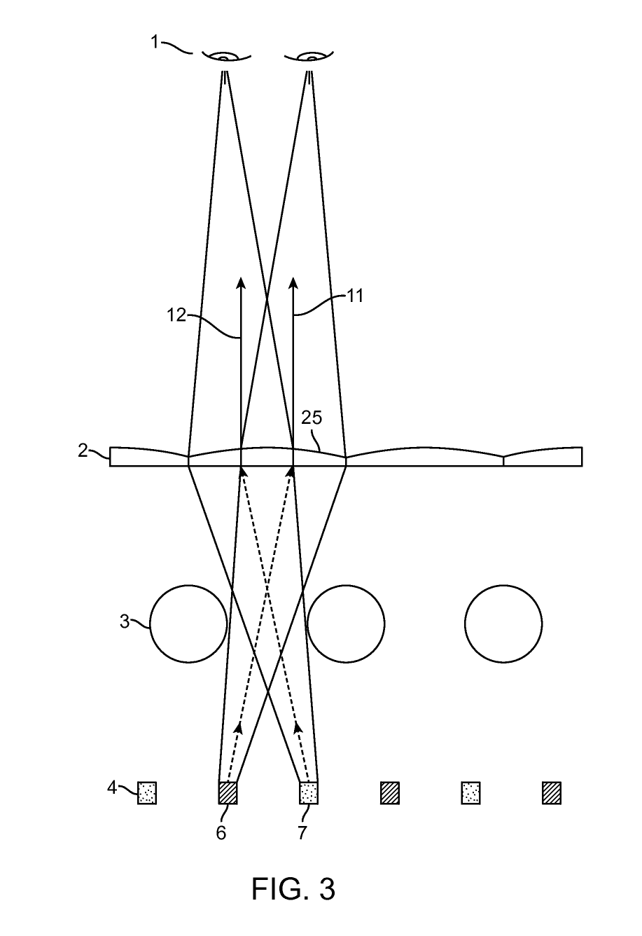

In FIG. 3 we illustrate what happens when we merge the Fresnel lens wedges 20 and 21 to their ultimate conclusion as single cylindrical lenses 25, and reduce the LEDs 6 and 7 to their minimal size as point sources. We thereby simplify the concept of steering the light from these sources to a pair of eyes 1. The principle rays 11 and 12 from LEDs 6 and 7 are shown clearly first as dotted lines to the cylindrical lens 25 and then refracted towards the eyes 1 as solid lines. This shows the two rays 11 and 12 clearly separated on reaching the eyes.

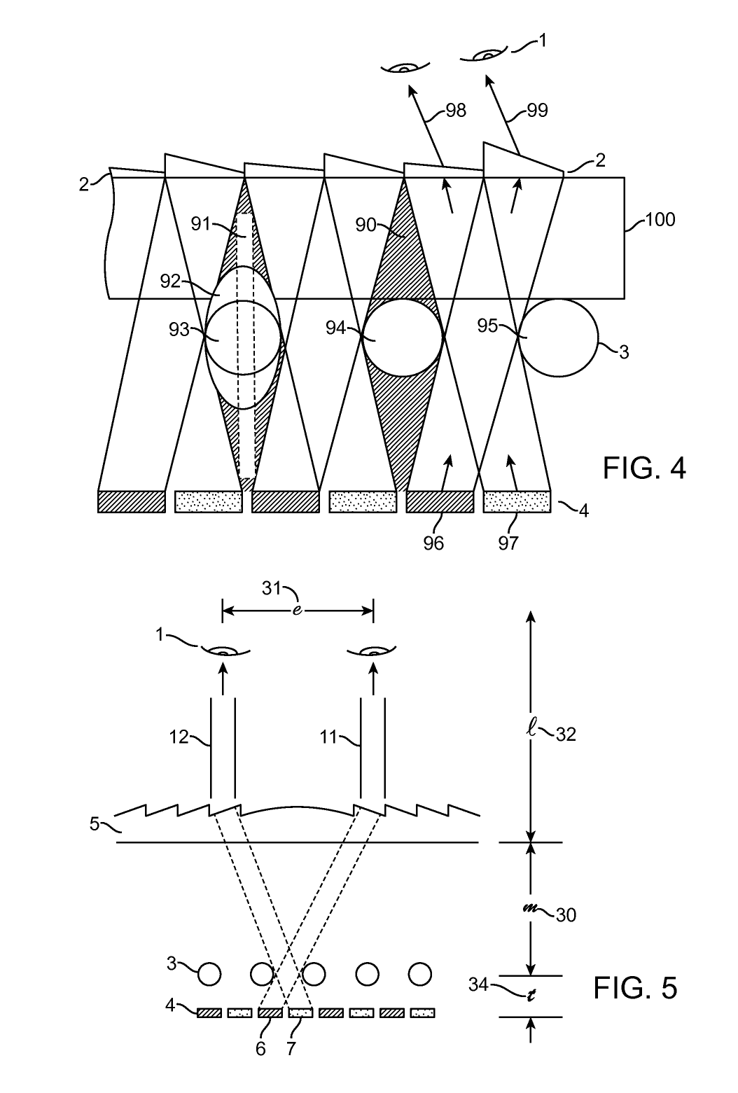

FIG. 4 shows several geometries which may be assumed by the apertures 3. For example lozenges 90 used as side-walls between apertures will block leakage from adjacent LEDs. However they may be impractical in manufacture. Bars such as 91, ovals like 92 and cylindrical sections like 93 as blockers are much easier to work with and the LED side-bands are manageable as is shown above from FIG. 1. Here we choose cylindrical sections for illustration.

FIG. 4 also shows how cylindrical sections 93, 94 and 95 can be attached to a flat substrate 100 for manufacturing. These sections can be printed on the substrate with a 3D printer to give shapes such as the round or elliptical sections shown, or even half-round or flat.

In the case of all shapes we take particular care to minimize the effects diffraction, dispersion and aliasing. We will discuss this later.

As a corollary to previous figures, FIG. 4 shows that at the extreme edge of a 55″ screen, 2′ from the centerline, an observer at a distance of 5′ will see the edge of the screen 100 at an angle of 22°. To direct the light precisely towards the viewer the two wedge angles (by calculation) then become 5° for the inner (“red”) beam 98 going to the right eye and 23° for the outer (“blue”) beam 99 going to the left eye, with the narrow ends of the wedges directed outwards. In this way the Fresnel lens can be tailored for each viewing angle from the center outwards.

In a further example at 10′ one or more viewers will see the edges of the screen at angles of up to 11°. It is still worth putting a small bias into the outlying Fresnel wedges to steer the main body of light towards the viewers.

It may be noted in these computations that an observer may be fairly comfortable viewing from a number of positions, since the images will track over a substantial range. We have simply computed the above as being optimal for a particular instance.

In any event, the structure of this particular Fresnel lens will be an accommodation with the relative viewing positions of an expected audience.

In a further refinement, in FIG. 5 we show where a condensing lens 5 (a circular Fresnel lens) can cause the light to flow almost parallel, so that observers can sit at a range of distances from the screen and still view it in full-depth in comfort. Separated by an appropriate distance, condensing lens 5 can be combined with shaping lens 4 to optimize the viewing optics. Lens 5 can also magnify the scene by some factor such as two or five times, which in itself enhances the full-depth effect.

In FIG. 5 the particular distance which causes this is where m/t=e/p where m (30) is the distance from the condensing lens 5 to the apertures 3. The distance l (32) from the observers to the condensing lens for comfortable full-depth viewing is typically from 5′ to 20′.

Returning now to FIG. 1 we have noted that using wires for creating apertures there are penumbras (areas of partial occlusion) 13 and 14 associated with each LED as they pass between the wires. Shown in this figure the main bodies of light 11 and 12 hit their particular prism sections 21 and 20 of the Fresnel lens squarely, but the beams 15 and 16 hit the counter-prisms 22 and 19 where they undergo even more refraction to steer them well away from the observer. This shows the importance of the positioning symmetry of the Fresnel lens 2 on the opposing side of the apertures 3 from the LED array 4, where they can be the most effective in steering the light.

We note that the choice of cylindrical sections 3 in forming the apertures coupled with their distance from the Fresnel lens 2 creates an ability to block or reject the side bands from adjacent LEDs almost totally. In the case of LED 8 a main body of light emerges between wire sections 41 and 42 to strike Fresnel lens section 19 squarely. This will be refracted through a large angle (shown as arrow 17) to be emitted out of viewing range. There is also a penumbra associated with LED 8 which emerges from wedge 20 at an angle similar to that of LED 7. This can (for example) be minimized either by increasing the wire diameter one or two hundredths of an inch or by reducing t and s, or both. In this configuration it is the only instance of overlap by adjacent bands. In the case of light emitted from adjacent LED 9 it can be shown that the cylindrical sections 41 and 42 occlude the emerging light almost totally, leaving only small residual penumbras. The light from the following LEDs is totally occluded. This continues for every other LED in the array.

We therefore see that increased separation of the Fresnel lens 2, the apertures 3 and the LEDs 4 may be necessary for mechanical or other reasons but it is not helpful within the scope of this invention. However the reduction of these dimensions will greatly reduce the side-bands.

Though we have chosen cylindrical sections as examples, because they are simpler conceptually and the easier to manufacture, should the oval or elongated structures from FIG. 4 shown to be as easy to manufacture they would be used also.

We have also worked with reducing the cylinders to flat sections. The main body of light from LEDs 6 and 7 will emerge normally, but the side-bands will have very little to block them. Light from will all LEDs will escape far to the sides at increasingly grazing incidences.

On all sections we have considered the effects of diffraction. When light from the LEDs hits a cylindrical section the ability to diffract is spread over the surface, so there will be less optical interference than from a flat section with sharp edges. Also at an average wavelength of visible light of 550 nm (or 0.55μ) and an aperture width of 0.025″ (or 635μ) the diffraction effects at this ratio (over 1100:1) are negligible. Even with a 4K screen and apertures of 0.012″ similar results (i.e. over 550:1) obtain to create very small diffraction effects.

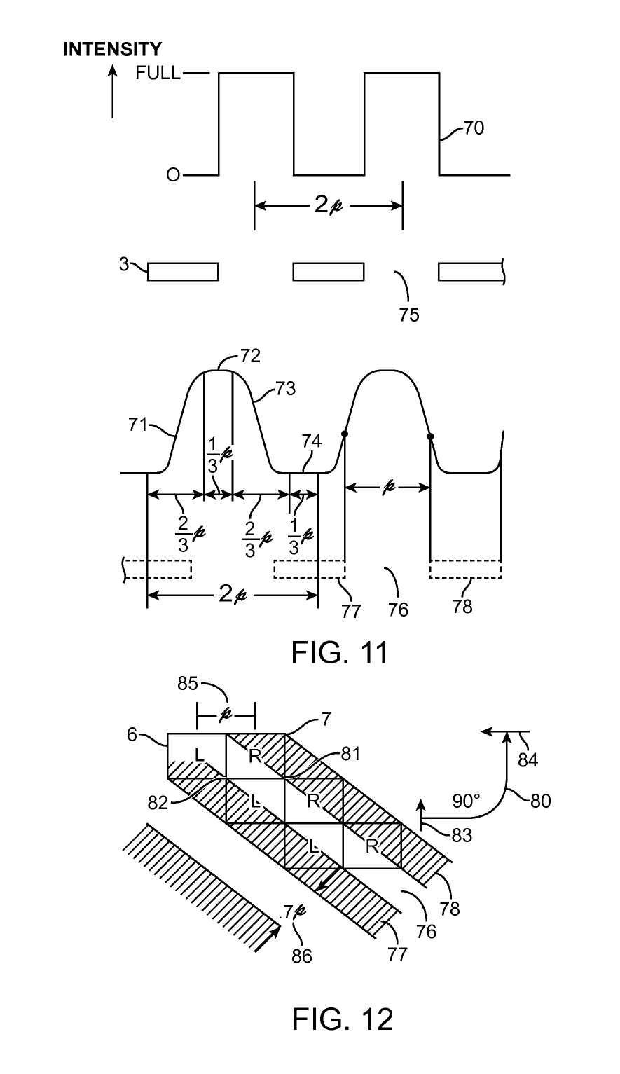

In FIG. 11 is shown a method we have used—and verified by experiment—to minimize diffraction and to eliminate aliasing in flat sections. On the left-hand side of the diagram is shown the expected light intensity as it emerges from a series of unaltered apertures 75. The light intensities 70 are essentially square waves. On the right-hand side of the diagram are shown the modified apertures 76. Here the side “walls” (as described from FIG. 4) have been reduced to flat sections 77 with a number of characteristics. When printed over the first period 2/3p the shape of the flat sections follows a sinc function sin (x)/x where x is in the spatial domain, appearing as slope 71. This covers the last third of flat section 77 and the first third of aperture 76. The next period 1/3p is empty, so light emerges at full intensity for duration 72. The following period 2/3p inverts the sinc function to slope 73, to the point where no light emerges. The last period 1/3p is fully obscure for duration 74.

Taken together the four periods 71, 72, 73 and 74 cover a complete cycle of 2p for every aperture of array 4.

Slightly harder to envisage or execute is a sinc function for all the possible apertures in this invention. For example, for cylindrical sections 93, 94 and 95 we have tried cotton thread with the correct diameter and consistency. This has given us not unreasonable results and may be a very inexpensive solution. (See below).

In terms of viewing pleasure the appearance of the screen (modified as described) is less granular than that of lenticular arrays such as those of other manufacturers.

In terms of accessing multi-view lenticular arrays in real-time, this is difficult because manufacturers have designed them for synthetic computer-generated inputs. It is easier to access an aperture system because with pixels pre-assigned for left and right views, there are no impediments to streaming data in milliseconds to create full depth.

If it is desired to switch to 2D from 3D or back again this can be done either with a mouse-click or with a remote control button, and the pixels can be immediately re-assigned to their original functions. In the case of a 4K or UHD format both will still be in HD.

In FIG. 12 is shown a corollary of this invention. By assigning the “left” and “right” pixels to run diagonally up the screen at 45°, such that all left views 6 are interleaved with all right views 7, with the apertures 76 straddling the LEDs by their diagonal corners 81 and 82, then full-depth viewing can be achieved both in landscape 83 (as shown) and in portrait 84, by rotating the screen counter-clockwise through 90°(80). This is because the “right” pixels 7 remain on the right and the “left” pixels 6 remain on the left throughout this quadrant.

In FIG. 12 if the separation of the pixels 85 is denoted asp then the separation of the apertures 86 will be 0.7p , because with square pixels the apertures will be running at 45° up to the left.

The pixel image format for FIG. 12 with its apertures running at 45° to vertical is

LRLR

RLRL

LRLR

with the pixels (LEDs) 6, 8 etc. creating the left-eye images and the pixels (LEDs) 7, 9 etc. creating the right-eye images.

If one turns the screen “upside-down” the same will be true if all pixel assignments are flipped between 6, 8 (left) and 7, 9 (right), which can be triggered instantly by a gravity sensor. This simply reverses the pixel image format given above. With this design one can do what no other manufacturer has so far done: achieve viewing in full depth from every orientation.

This would seem particularly useful for full-depth viewing of images in smaller devices such as tablets and cell phones, since the apertures would be at an exceedingly small distance, e.g. 0.010″ away from the LEDs and a Fresnel lens, if needed, at 0.010″ again. This inexpensive system of apertures and lenses could be embedded directly by a device manufacturer.

For smaller devices such as tablets and cell phones the Fresnel lenses are not strictly necessary, although an embedded Fresnel lens magnifying up to 5× may be desirable to enhance the full-depth effect, or for improving the view for those with poor eyesight.

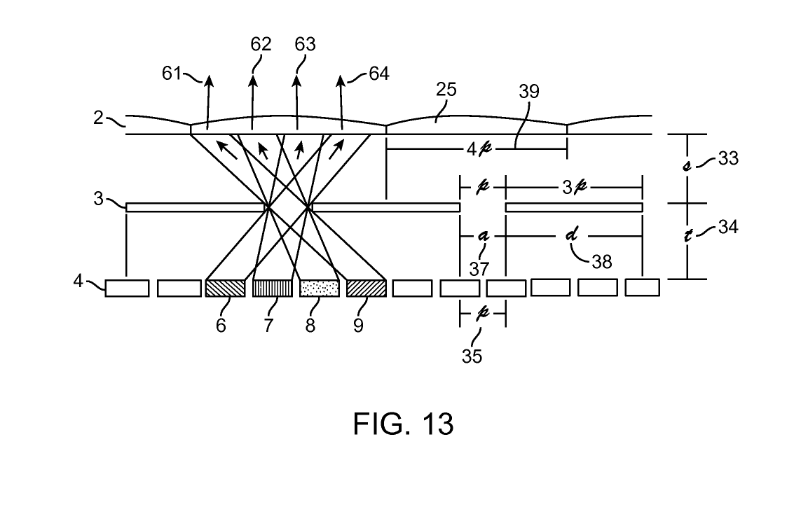

In FIG. 13 is shown another corollary of this invention. It is that the number of possible viewpoints can be greater than two. This enables the showing of images in richer depth from three, four or more coordinated cameras. This will be especially true as the intensity of LEDs is steadily improved.

Our example in FIG. 13 shows how a set of four separate images can be assigned to columns represented by LEDs (or pixels) 6, 7, 8 and 9. The pixel image format for this is

LMRS

LMRS

LMRS

LMRS

with the pixel columns 6 (L) and 7 (M) creating images on the left, and the pixels (LEDs) 7 (R) and 9 (S) creating images on the right, in relation to aperture 37. This aperture a (37) has a width very close top to properly separate the emitted light into beams 61, 62, 63 and 64. The width of the bars d (38) is 3p, so that a+d=4p because if a is optimized to be wider or narrower a+d always adds up to the period of four pixels.

It is very easy to see from here that if the apertures are made to run at 45° to the screen vertical up to the left (as in FIG. 12) then the four-view pixel image format becomes

LMRS

SLMR

RSLM

MRSL

with the pixels assigned as in FIG. 13, but now in the appropriate diagonal manner as in FIG. 12.

The apertures and LED assignments could just as easily run up to the right, which would mean rotating the screen clockwise through the left lower quadrant to see full depth continuously. For all diagonal arrangements full depth should be visible almost semi-circularly about this quadrant without inverting the LED assignments.

From FIG. 13 the light directed through the apertures is refracted by a cylindrical lens 25 of width 4p (or 0.28p in the case of diagonal) to emerge slightly divergent or parallel. For symmetry the distances s from lenses 2 to apertures 3 and distance t from apertures 3 to LEDs 4 are equal. Beyond lenses 2 the beams 61, 62, 63 and 64 can later be refracted parallel by a condensing lens (such as lens 5 in FIG. 5) so that perfect images can be created at any distance.

The same general rules apply for three, five or more viewpoints. The aperture width always remains p. For example the pixel image format for three viewpoints running vertically is

LMR

LMR

LMR

with L being the left, M being the middle, and R being the right pixel.

All assignments and re-assignments of pixels 6, 7, 8 and 9 for any particular purpose are done by adding to or rewriting the internal TV screen or monitor software. Generally the access time for writing to the screen (i.e. sending data) or re-assigning the pixels is in milliseconds, typically 20 ms for local data at 1920p, slightly longer for remotely streaming data, depending on the packet sizes and the vagaries of the Internet.

We have carried out extensive work on the creation of mesh apertures and the means of mounting them.

One method tried has been to string a wire, such as a black anodized aluminum wire with a 0.025″ cross-section, over a frame vertically on a 0.050″ period. This involves the use of up to 2,000 feet of wire on 960 passes (1,920 for 4K) without kinks or breakages. The wires provide a very clean section. Clear nylon filament has also been tried with good results. However wires, filaments, twine, thread, etc. suspended like this cannot easily maintain even separations over any length above about ¼″.

A method to overcome this is to affix the wires directly against, or to embed them in, a flat plate. We have already done this by CO2 laser cutting slots directly into Plexiglas plates. Unfortunately the laser cuts into the intermediate clear sections irregularly, reducing their ability to transmit light cleanly.

A method to simulate affixing cylindrical sections to a flat plate is to use a 3D printer to extrude a 0.025″ filament (black, frosted or clear) which will stick on a clear glass or Plexiglas sheet. To keep it consistent in over 960 passes the bead must be monitored and controlled in process optically. We would prefer perfect accuracy but we have found that with a diameter of 0.025″ a tolerance such as ±0.002″ in size and position is possible and acceptable.

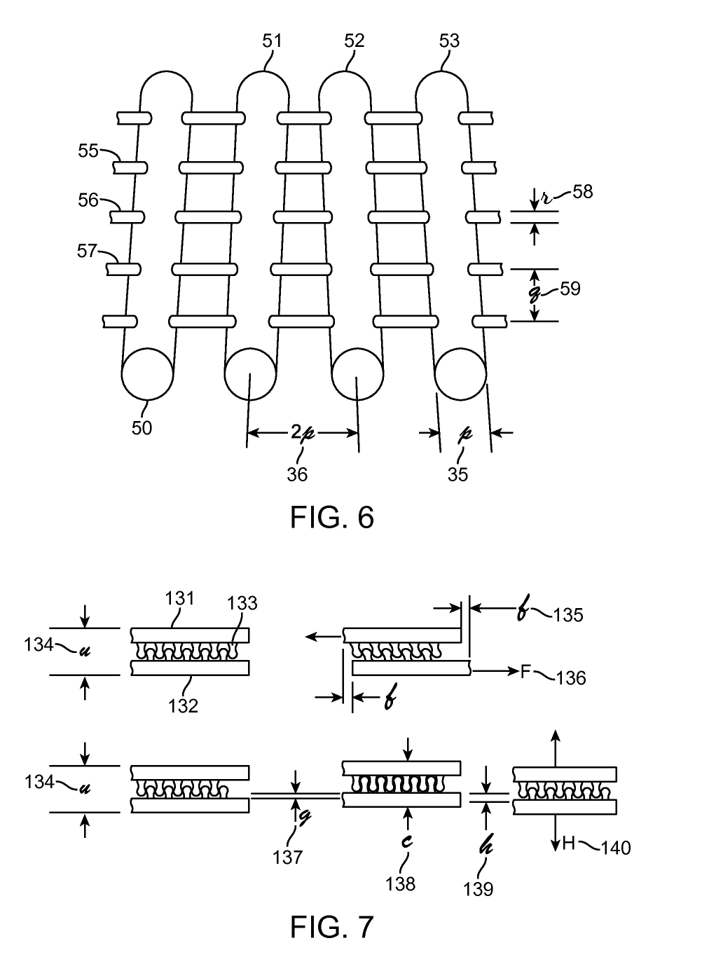

Another method of creating a wire mesh 50 is shown in FIG. 6. Here the wires (52) can be printed in 3D on 2p (36) centers with defined diameters p (35) of 0.025″. We can also add cross-braces (56) of 0.005″ diameter r (58) every ¼″ g (59) which will barely be perceptible in use, but strong enough to keep the wires parallel. If printed on a substrate the wire mesh can be lifted off intact using a release agent, or if the substrate is appropriate simply left in place.

Our preferred section is cylindrical for implementing wire apertures. Sometimes there is a certain flattening of the section as it is deposited on a glass, plastic or other transparent substrates but not to any functional detriment. We can deposit other sections including half-cylinder, oval, polygons and flat in various orientations and dimensions. However, for ease of conceptualization, manufacturability and use, cylindrical sections appear to work the most easily.

It makes little apparent difference to the results whether the sections are frosted, clear, grey or black. Frosted or clear are more desirable because they are less conspicuous.

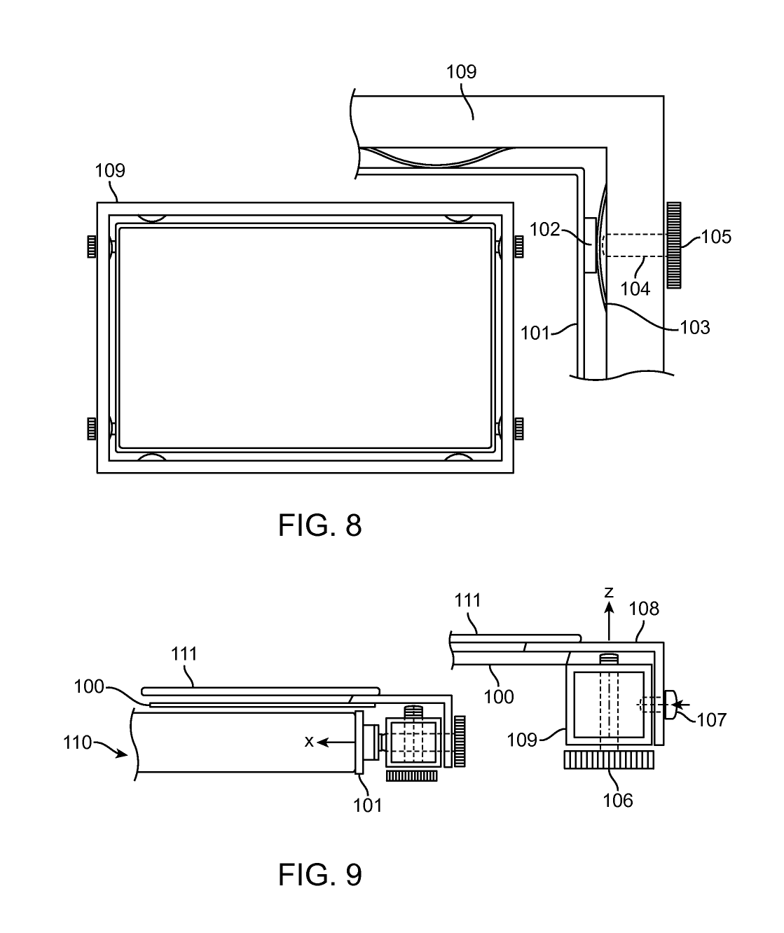

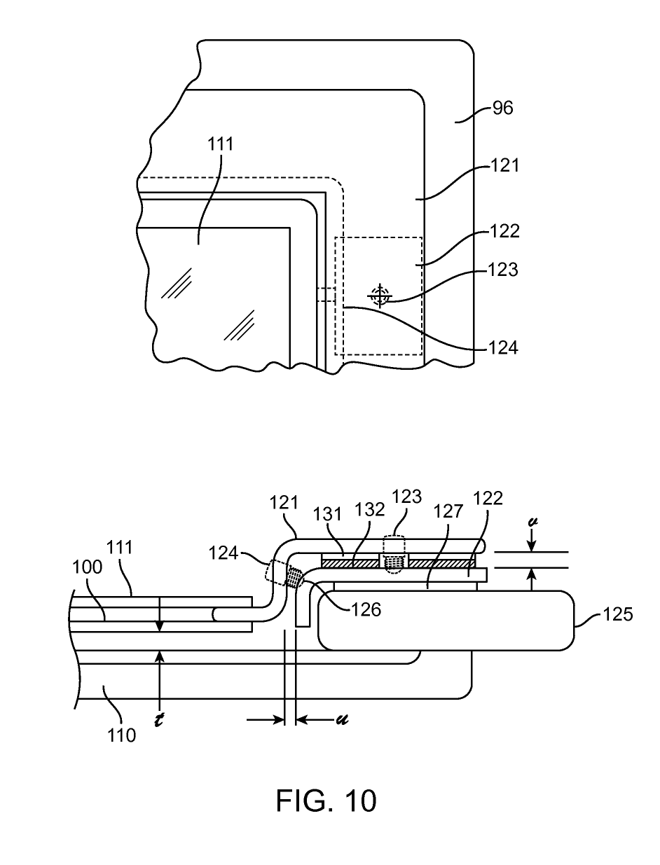

As seen in FIG. 8, FIG. 9 and FIG. 10, in every case the screen modifier 100, however constructed, needs a frame or a frame combination for mounting to an existing TV or monitor. In every case we design the entirety of screen modifier 100 and frame to be light-weight.

It is preferable that a holding frame 121 (which follows below) or a sub-frame 109 (which follows later) are designed so that they do not mar the TVs which they are enabling, either in attachment or in detachment.

A simple means of attachment which allows for adjustment is shown in FIG. 7. Velcro (or its equivalent with interlocking heads) can allow a holding frame to be fastened easily onto the outside of any type of TV with a bezel. The holding force must be enough to hold the frame's weight during adjustment, which is until it is locked.

In FIG. 10 the Velcro is shown attaching the frame edge 121 to the pad 122. By adjusting the screw 123 upwards, a force 140 is applied to stretch the Velcro, increasing the gap v between the frame 121 and the pad 122 by an amount h. This will bring the screen modifier 100 further away from the TV screen 110 by the same amount h. Similarly for the lateral adjustment the Velcro can be stretched left or right with a displacement f by adjusting lateral screws 124. The screws 124 can also be used differentially to rotate the apertures 3 in the screen modifier 100 to bring them into alignment with LEDs 4 on the TV screen 110. Screws 124 can also help to firmly lock the holding frame 121 laterally against pad 122 once adjustments are made.

In all cases the amount of adjustment required to bring apertures and LEDs into alignment is small, for a large (55″) screen in the order of 0.020″, well within the stretching capacity of the particular Velcro used.

FIGS. 8 and 9 show a different approach for a sub-frame 109, for attachment to a TV or monitor with metal edge and no bezel.

Here, for reference, we use the coordinates x, y and z for the different axes required for aligning the screen modifier apertures 3 with Fresnel lenses 2 with the monitor LEDs 4. The monitor axes are x (seen normally as horizontal), y seen normally as vertical, and z away from the TV towards the viewer.

For precision alignment we need two frames: a sub-frame 109 for the x and y axes adjustments and a top frame 108 for the z-axis adjustment. Sub-frame 109 is made with aluminum box tubing and top frame 108 made with aluminum angles for the combination to be adjustable on three axes, plus light, stiff and strong. These frames together are “light-weight structural elements”.

In FIG. 8 we show the sub-frame 109 attached to a typical monitor (or TV) 110 with pads or magnets 102. This particular TV has a circumferential ferrous edge 101 exactly 1 mm thick, and no alteration or attachments to this unit are necessary. The magnets (in the four positions shown in FIG. 8) are attached to sub-frame 109 with leaf-springs 103 in such a manner that a thumb-screw 104 with a fine pitch thread (such as a 10-40) can adjust the spring up to 0.012″ to “nudge” (for exceedingly small motions) the sub-frame so that the apertures 3 on modifier 100 are brought into precise horizontal alignment with the LEDs 4 on the monitor. The strength of the magnets is 4 to 5 lbs each giving a temporary holding force of 16 to 20 lbs, enough to hold the sub-frame well enough, but not so tightly that it cannot be adjusted and if necessary, detached and replaced.

The thumb screws 105 (which can be set-screws) are set in four places 110 on the vertical edges and with a small differential adjustment (e.g. ±0.005″) can also do the vertical (or skew) alignment of the wires on sheet 100 with the LEDs 4 to bring them into precise vertical registration. Within one or two iterations (after some adjustments with top frame 108) the four thumb screws 105 can lock the sub-frame 109 into place. We note that springs 103 only, without thumb screws, are required top and bottom since generally no up or down alignment is required.

Top frame 108, which holds the aperture sheet 100 and the protective glass cover 111, is designed to snap over the sub frame 109 in such a manner that it is adjustable on the z-axis. This adjustment is achieved with thumb screw 106 which can raise or lower top frame 108. When this is adjusted perfectly, the frame can be locked with side screw 107.

To remove and replace holding frame 108 we can either loosen or remove the four screws 107, or if it is desired to return the TV 110 to its original condition, remove the sub-frame 109 entirely by loosening the thumb screws 105 and sliding off the pads or magnets.

Ultimately it will be better—certainly more convenient to customers—if all screen modifiers 100 are built into TVs 110 as original equipment so that all adjustments are pre-set and no external adjustments are required.

While the invention has been described and illustrated (in general) as one in which arrays of apertures may be combined with Fresnel lenses to separate left and right perspective views in order to create full-depth vision, to those skilled in the art it will be clear that other derivations of this technology are possible. These derivations include (but are not limited to): other separations of the elements 1, 2, 3, 4 and 5; differing angles across screen 4 for apertures 3; differing periods for 2 and 3; differing configurations and materials of the elements of aperture array 3; differing focal lengths and distances to single or multiple observers; differing manners, means and materials for attaching, adjusting, detaching and replacing screens containing elements 2, 3 and 5.

It may be understood that although specific terms are employed, they are used in a generic and descriptive sense and must not be construed as limiting. The scope of the invention is set out in the appended claims.

We claim:

1. A method for creating full depth viewing from a flat or curved screen possessing light emitting elements comprising
software for assigning appropriate light emitting elements within the screen to create images for left and right eye views
an array of apertures for guiding the light from the appropriate light emitting elements into left and right eye views
a lensing system to guide the light emanating from the array of apertures into diverging, converging or parallel left and right eye views as appropriate

2. The method as in claim 1 wherein the apertures are formed by a series of shapes running parallel to the light emitting elements

3. The method as in claim 1 wherein the apertures precisely straddle the light emitting elements so that the light from each light emitting element assigned as “left” is directed through its aperture towards the lensing system for direction towards the left eye and the light from the light emitting element assigned as “right” is directed through its aperture towards the lensing system for direction towards the right eye.

4. The method as in claim 1 wherein the lensing system is a series of lenslets, prisms or wedges running parallel to and precisely straddling the apertures to direct the light emerging from the apertures to the right and left eyes as appropriate.

5. The method as in claim 1 wherein the lensing system may also contain a separate condensing lens so that the emerging light can be made to flow substantially parallel towards the eyes at an appropriate separation to allow a viewer to see images in full depth at a range of distances.

6. The method as in claim 1 wherein the aperture walls may in cross-section be circles, ovals, bars, lozenges or other shapes as appropriate for guiding the light and blocking side-bands.

7. The method as in claim 1 wherein the aperture walls have edges shaped for eliminating aliasing and smoothing the images.

8. The method as in claim 1 wherein the apertures are formed by a set of shapes running diagonally to the light emitting elements and the light emitting elements are assigned as “left” or “right” run in diagonal steps parallel to the apertures.

9. The method as in claim 8 wherein the light emitting elements assigned as “left” are substantially on the left hand side of the apertures and the light emitting elements assigned as “right” are substantially on the right hand side of the apertures so that a screen may be viewed either in landscape mode or in portrait mode when rotated orthogonally within one quadrant.

10. The method as in claim 9 wherein the orientation of the device can be sensed by a gravity sensor allowing the pixels to be interchanged between “left” and “right” in a diametrically opposed “upside-down” quadrant.

11. The method as in claim 8 wherein the apertures can be built into tablets or other viewing devices, the devices being any size but generally smaller, allowing their images to be seen in full depth from any direction.

12. The method as in claim 1 wherein the number of views is not limited to two but can be three, four or more.

13. An apparatus for enabling full depth vision from a flat or curved screen possessing light emitting elements comprising
an adjustable frame of sufficient stiffness to support an array of apertures and lenses which may be attached to the screen
screws or adjusters for aligning the frame precisely with the screen
screws or devices for locking the frame precisely in place on the screen

14. The apparatus as in claim 13 wherein the apparatus is light in weight through the use of Fresnel lenses, light-weight meshes, wires, threads or printed apertures, and light-weight structural elements.

15. The apparatus as in claim 13 wherein the adjustable frame can be attached easily to the screen using Velcro or equivalent.

16. The apparatus as in claim 13 wherein the Velcro or equivalent enables the adjustments necessary for alignment by stretching or compressing it.

17. The apparatus as in claim 13 wherein one form of a light-weight mesh is printed using a 3D printer and has cross-braces for the even separation of aperture spaces.

18. The apparatus as in claim 13 wherein the frame can be attached to, or removed from, a TV or other viewing device without marring the viewing device.

19. The apparatus as in claim 13 wherein one or other or both Fresnel lenses may not be used.

20. The apparatus as in claim 13 wherein the apertures and lenses can be built into a TV or other viewing device directly by a manufacturer.
